(19) United States
(12) Patent Application Publication
(10) Pub. No.: US 2003/0216824 A1
(43) Pub. Date: Nov. 20, 2003

(54) Method and apparatus for self-degrading digital data

(75) Inventors: Hao-Hua Chu, Mountain View, CA (US); Khosrow Lashkari, Fremont, CA (US); Ged Powell, San Jose, CA (US)

Correspondence Address: BRINKS HOFER GILSON & LIONE, P.O. Box 10395, Chicago, IL, 60610, US

(73) Assignee: DoCoMo Communications Laboratories USA, Inc.

(21) Appl. No.: 10/146,404

(22) Filed: May 14, 2002

(51) Int. Cl. G06F 17/00; H04R 29/00

(52) U.S. Cl. 700/94; 381/56

(57) ABSTRACT

When copies of digital are made or after use of the digital data, the quality of the digital data is reduced or degraded. The degradation may be in any way suitable to the nature of the digital data. In one embodiment, the content provider which originates the digital data may specify a degradation policy or degradation specification model for the digital data. When the digital data is copied or moved, the copy is degraded according to this specified policy or model. In this manner, the content provider can control the extent to which the end user can copy the material. The end user can make copies limited in number only by the degradation of the digital data.

### BACKGROUND

The present invention relates generally to data communication. More particularly, the present invention relates to a method and apparatus which incorporate self-degrading digital data, for example, for digital rights management.

A significant feature of digital data is that it can be duplicated precisely, over many generations, without error. In fact, many data communications techniques have been developed to ensure error free communication. Put another way, the quality of digital data does not degrade after usage. It is possible to duplicate and re-duplicate, or distribute and re-distribute, digital data between a source and a destination without losing the original quality of the data.

In this context, quality as applied to digital data can have a variety of meanings. For digital data which encodes audio or video information, high quality data may produce a decoded version of the original which is substantially indistinguishable from the original. Medium quality data may produce a decoded version of the original which is noisy or distorted relative to the original, but still acceptable. Low quality data may produce a decoded version of the original which is unacceptable. For digital data which encodes numerical information such as stock quotes, high quality data may include real-valued data faithfully accurate to the smallest decimal. Degraded data may be rounded to a value such as the nearest integer. In general, the quality of digital data may be specified by an objective or subjective measure that relates the data after copying or usage to the data before copying or usage.

The accurate, even flawless, reproducibility of digital data can lead to undesirable consequences. For example, users may illegally share files of copyrighted multimedia data, such as data encoding audio or video images. In one widely publicized example, the file and music sharing application Napster, developed by Napster, Inc., allows ordinary personal computer (PC) users to download and distribute copyrighted music files over a network such as the Internet. Since the quality of digital data does not degrade, a single source file can be rapidly duplicated into a large number of copies. These may be referred to as generational copies, in which a first generation copy is the source of a second generation copy. The copies can be distributed identically and rapidly over the Internet or any other media.

Several digital rights management (DRM) systems have been developed or proposed to attempt to control the illegal copying and distribution of digital data. Examples include the Secure Digital Music Initiative (SDMI) standard, the Electronic Media Management System (EMMS) developed by International Business Machines, Inc., and used, for example, in the M-Stage music distribution system developed by NTT DoCoMo, and the RealSystem Media Commerce Suite developed by Real Networks. In each of these systems, a content provider makes digital data available for use by end users by providing a control policy on how data may be copied.

These systems have met with some success but still have limitations. In general, the content providers' control policies create rigid rules which are not readily adaptable to the particular needs of an end user. For example, the number of copies which may be made is tightly controlled. In another example, the end user may have to manage his copies carefully, for example, by returning one copy before a new copy can be made. Since some users have multiple devices on which they might like to share copies of data, such as multiple MP3 players, these rigid rules can be inconvenient for many users and can limit the market for digital data from a content provider.

Accordingly, there is a need for an improved method and apparatus for data duplication and distribution.

### BRIEF SUMMARY

By way of introduction only, the present embodiments provide for self-degrading digital data which may be considered to mimic the analog duplication process. When digital copies are made or after use of the digital data, the quality of the digital data is reduced or degraded. The degradation may be in any way suitable to the nature of the digital data. For example, if the digital data encodes music, the degradation may take the form of spectral distortion introduced to reduce the playback audio quality. If the digital data encodes video, the degradation may take the form of noise introduced to reduce playback picture quality, or varying the signal to noise ratio of signals produced using the digital data. If the digital data encodes scalar data such as stock quotes, the degradation may take the form of reducing decimal-place accuracy of the stock quotes.

In one embodiment, the content provider which originates the digital data may specify a degradation policy or degradation specification model for the digital data. When the digital data is copied or moved, the copy is degraded according to this specified policy or model. In this manner, the content provider can control the quality of end user's copied material. The end user can make copies limited in number only by the degradation of the digital data.

The foregoing discussion of the preferred embodiments has been provided only by way of introduction. Nothing in this section should be taken as a limitation on the following claims, which define the scope of the invention.

### BRIEF DESCRIPTION OF THE DRAWINGS

FIG. 1 is a block diagram of a portable device;

FIG. 2 is a process flow illustrating digital data management; and

FIGS. 3-5 illustrate a set of digital data degradation models.

### DETAILED DESCRIPTION OF THE PRESENTLY PREFERRED EMBODIMENTS

FIG. 1 is a block diagram of one embodiment of a portable device with which self-degrading digital data may be incorporated. In one embodiment, a portable device or PD is typically a small, easily transported device that can play digital music. The music is stored on internal (fixed) or portable media. Portable media are media types that can be transferred to/among players. SDMI has been active in developing requirements for PD security. PDs referred to as “SDMI-compliant” are intended to store and play protected content.

The portable device 100 may be any data processing device capable of operating in response to data or instructions received at the communication interface 106. Examples includes a wireless communication device such as a cellular or personal communication system (PCS) radiotelephone, a personal digital assistant (PDA), a personal computer (PC) which accesses data over a network using a wireless link or a wireline link, a video device such as a video cassette recorder or DVD player, an audio device such as an MP3 player, or another device incorporating such a device. The data processing device 100 in the illustrated embodiment is portable and may include a battery for powering the data processing device 100. In other embodiments, the data processing device may be a fixed device such as a desktop computer, a home entertainment center, or other device.

In accordance with the present embodiments, the digital data received by the portable device 100 includes self-degrading digital data. Self-degrading digital data is data stored digitally but its quality can degrade as it is being accessed from devices such as the portable device 100, moved and copied from one device to another. The motivation for self-degrading data comes from the observation that the quality of digital data, in contrast to analog data, does not normally degrade after usage. It is possible to duplicate or distribute digital among multiple devices many times without losing the original quality of the digital data. Essentially flawless copies are routinely made.

This digital property leads to undesirable consequences in illegal file sharing of copyrighted multimedia data, such as audio, video and image data. Since the quality of digital data does not degrade, it is possible for one source file to be rapidly duplicated into thousands or millions of generational copies.

This is in contrast to analog data, an example of which is a cassette audio tape. When a typical user copies analog data from a source medium to a destination medium, some data quality is lost. The playback and recording equipments introduce some noise. Some spectral distortion or even time distortion is introduced. This is referred to as generational loss and happens on both the source medium, due to the playback, and the destination medium due to recording. It takes a limited number of copies to reach the stage where degradation in data quality becomes unacceptable to users. This self-degrading property of analog data has shown to discourage the problem of illegal copies among home users. Due to this generational loss, good analog duplication requires expensive recording equipment usually not available to a typical user. Analog duplication is also time consuming and its distribution requires physical media such as cassette tapes and long playing records (LPs).

Digital rights management (DRM) systems have been proposed or implemented which are based on a closed system design to track and enforce the maximum number of permitted copies that may be made from an original. Once digital content enters the closed system, it is kept within the closed system and is subject to usage and duplication rules set forth by the closed system. It is herein assumed that a closed system is available that monitors copy and move operations and provides an alert signal whenever these operations might take place, over a network, in a PC, a PDA or other data processing device.

In one embodiment, self-degrading digital data introduces generational loss associated with analog data into digital data as a new usage or duplication rule to enhance existing DRM systems. Duplication rules in such existing systems, which limit the number of copies that can be made from an original, are too restrictive to users because of the number of devices that a single user owns and because of usage practices such as music sharing among friends. Using duplication rules incorporating self-degrading digital data, existing DRM systems can offer users the flexibility to make as many copies as they require. At the same time, these systems can protect content providers by lowering the quality of copies when too many copies are made. In this embodiment, self-degrading digital data is only focused on the usage and duplication rules component of DRM, rather than being a proposal for an entire DRM system. Since self-degrading digital data is focused in this embodiment specifically on usage and duplication rules, other DRM issues are outside the scope of this embodiment. Examples include encryption, storage and screening. It is assumed herein that DRM systems using self-degrading digital data are properly designed to ensure a secure, closed environment that can enforce usage and duplication rules for digital contents.

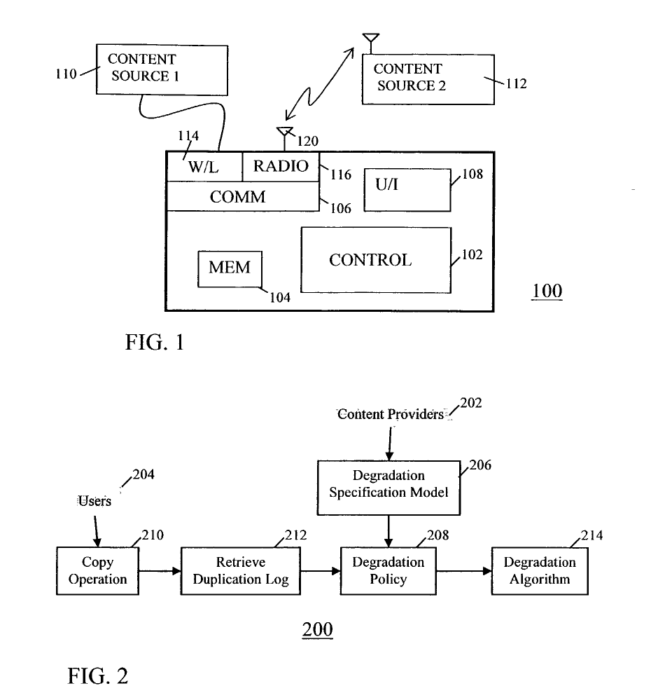

FIG. 2 is a process flow 200 illustrating digital data management, for example in the portable device 100 of FIG. 1. The process flow 200 of FIG. 2 is one exemplary embodiment of a digital rights management (DRM) method incorporating self-degrading digital data. The process flow 200 illustrates a method which in one embodiment includes receiving digital data and, after use of the digital data, degrading quality of the digital data. Use in this context may include copying the digital data or moving the digital data.

The process flow 200 of FIG. 2 requires input of content 202 and action by users 204. The content is degraded in accordance with a degradation policy 208 specified by the content provider based on degradation specification model 206. The process flow 200 also includes a copy operation 210 or other user action which causes retrieval 212 of the duplication log of the content for the user. The duplication log is another input to the degradation policy 208. In accordance with the degradation policy 208, a degradation algorithm is activated.

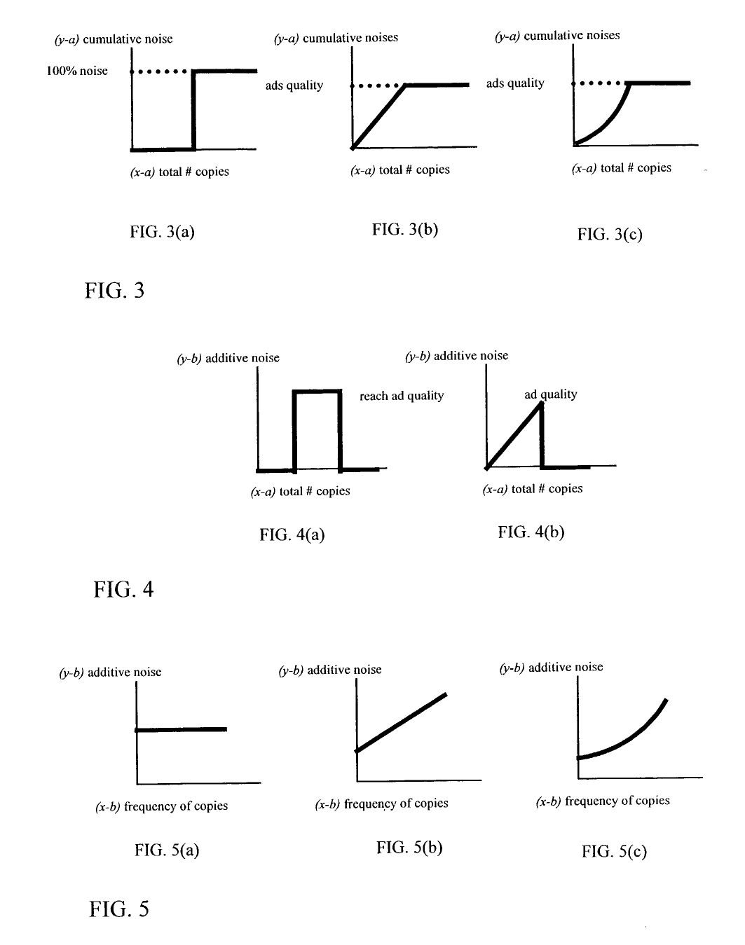

The content 202 may be any digital data file or information including digital data. The digital data may only form a part of the content. In the illustrated embodiment, the content includes both self-degrading digital data and a degradation policy 208. Examples of degradation specification models will be described below in connection with FIGS. 3-5. As noted, the degradation policy 208 may be incorporated in the content along with the digital data forming the data of interest to the consumer or user, such as audio data. Alternatively, the degradation policy 208 may be stored separately from the content itself. In one example, the degradation policy 208 is stored in audio playback devices and applied uniformly to all audio data files played on the device. However, combining the digital data of interest with the degradation policy 208 allows the content provider to tailor the model 206 to the particular end user or market for the content.

In this embodiment, preparing content includes storing in a distribution file digital data associated with the content. The digital data may be, for example, MP3 encoded audio data or a list of securities and associated stock quotes. The method further includes storing in the distribution file a degradation policy 208 defining how the digital data should be degraded after usage by a receiving end user. A duplication log may also be stored in the distribution file. The duplication log is a file indicating a duplication history for the digital data. The method then includes distributing the distribution file, which may be any method of placing the file into commerce, such as packaging floppy disks or CD ROMs for shipping to retail outlets, transmitting the distribution file over a network such as the Internet, either wirelessly or by wire. Any part or the entire distribution file may be encoded, such as by data compression or encryption, for distribution.

In yet another embodiment, content 202 may be embodied as a distribution file encoded as an electrical signal readable by a data processing device. The electrical signal may be received over a network such as the Internet. In a wireless embodiment, the electrical signal may be produced by a radio transmitter/receiver or other wireless communication interface.

The degradation specification model 206 may be used by content owners to define various degradation policies 208, such as the degradation policy 208. The degradation policy determines how the content is degraded based on, for example, the permitted number or frequency of duplications. The degradation process introduces predetermined error characteristics into the copied digital data. Here, the copied data may be considered distorted data because it is not an exact duplicate of the original data.

The users 204 represent individuals, entities or devices which require the content 202 and have access to the content 202. Access to the content 202 may be defined by any suitable digital rights management controls and may be based on, for example, purchase of a copy of the content on a computer readable form such as a floppy disk or CD-ROM or download of a copy of the content as an electrical signal over a network. The download may be by radio signal converted to electrical signals.

A user 204 initiates a copy operation 210. This may be any operation to move the content 202 from one location to another, to make a duplicate of the content 202 or to modify or make a derivative work of the content 202. The copy operation 210, may be explicit, such as clicking or actuating a copy operation on a word processing or audio or video processing device. Alternatively, the copy operation 210 may be implicit, as when digital data are accessed at a storage location and a copy of the digital data must be made from a storage medium into the working memory of the device. The copy operation 210 may be hidden, such as an operation which is controlled by microcode or programming instructions which are invisible to the user 204.

Initiation of the copy operation produces an access to the duplication log 212. Each copy operation results in an entry being added in the duplication log. Each entry in one embodiment records the time of the copying operation. In other embodiments, a copy tally may be maintained, and other information may be stored in the duplication log as well. The duplication log comprises data or instructions storing information about the duplication history for the content. In one embodiment, the duplication log stores all previous duplication history for the content. The duplication log can be stored in any convenient location or format. In one embodiment, the duplication log is stored with the content 202 as metadata. That is, the data forming the duplication log are stored in the same physical location as the content 202 and moved and copied with the content 202. However, preferably only authorized modifications may be made to the duplication log. The duplication log is used by the duplication algorithm 214, in combination with the degradation policy and degradation specification models, to decide the amount of degradation to be introduced into the source and the copy.

The degradation algorithm 214 is actuated by the degradation policy to actually degrade the digital data. The amount of degradation is specified by the degradation policy and the contents of the duplication log. In one embodiment, the content 202 is a data file stored in compressed format, such as an MP3 audio file or an MPEG video file. MP3 and MPEG are industry standard data compression and communication formats. Preferably, the execution of the degradation algorithm is fast enough to support real time playback and copying operations. That is, the degradation algorithm should operate directly on the compressed data and without introducing any time delay in the playback or copying of the content data file.

After degradation, the degraded digital data may be forwarded to a data destination. This may include forwarding to a playback function, such as an MP3 audio player, forwarding to memory for storage within a portable device, or forwarding to external storage such as to a Memory Stick® memory storage device made by Sony Corp.

FIGS. 3-5 illustrate sets of digital data degradation models. Degradation models can be represented as a curve in a two dimensional graph. This curve is referred to herein as a degradation function. The goal of one embodiment of digital rights management using self-degrading data is not to provide any specific degradation policies to content providers. Rather, the goal is to provide a model where content providers can specify their own degradation policies. One embodiment provides the models shown in FIGS. 3-5 and described below. It is within the purview of those ordinarily skilled in the art to describe other models and implement them to achieve particular design and operational goals. In the embodiment of FIGS. 3-5, there are two possible definitional choices for the x axis or abscissa of the degradation function. (x-a) is the cumulative number of copy operations, such as 5 copies. (x-b) is the frequency or rate of copy operations, such as 5 copies per week. Other abscissa specifications may be substituted. For example, a quadratic relationship may be used, or the values of (x-a) and (x-b) may be independently scaled by a scalar or other value. The difference between (x-a) and (x-b) is that (x-a) does not take into consideration the time interval between successive copy operations. (x-b) does take this into consideration.

Similarly, in the embodiment of FIGS. 3-5, there are two possible definitional choices for the y axis or ordinate. (y-a) is the cumulative amount of noise or degradation that is added to the original quality of the copy, including the noise that will be added in the current copy operation, such as 20 percent noise added to original copy. (y-b) is the additive amount of noise or degradation added in the current copy operation along, such as 5% noise added to the master and the slave tape. The difference between (y-a) and (y-b) is whether the degradation in the current copy operation is based or scaled on the original copy or the previous copy, which is the source file copy.

By choosing different combinations of {(x-a), (x-b)} or {(y-a), (y-b)}, four possibilities can be defined. Among the four, three are meaningful degradation specification models for content providers. A content provider can select one of the models to be used as the basis for their usage rule. In addition to selecting the degradation specification model, content providers also must specify the degradation function consistent with previous definition.

FIG. 3 illustrates three sample degradation functions. These curves illustrate an (x-a) and (y-a) specification model. FIG. 3(a) corresponds to the usage rule in the Secure Digital Music Initiative (SDMI) and in the Electronic Media Management System. The abscissa or x-value represents the permitted number of copies. In a first regime, when the number of copies made is fewer than the permitted number of copies, the added degradation is substantially zero. When the number of copies meets or exceeds the permitted number of copies, in a second regime the cumulative noise is increased so that the digital data is substantially all noise and completely degraded. Thus, the degradation policy in this embodiment includes copying the digital data substantially identically to produce degraded digital data until a maximum copy threshold has been exceeded.

FIG. 3(b) and FIG. 3(c) correspond to usage rules where the amount of degradation increases linearly (FIG. 3(b)) or exponentially (FIG. 3(c)) with the number copies made. In all cases, the degradation increases as the number of copies made from the original increases. In the illustrated embodiment, the degradation increases until a level referred to as advertisement quality is reached. Advertisement quality may correspond to high levels of noise or distortion introduced into the copies or original. Other degradation saturation conditions may be substituted, such as degradation until a one hundred percent noise point is reached.

FIG. 4 illustrates a (x-a) and (y-b) degradation specification model. Here, noise is determined incrementally rather than cumulatively as in FIG. 3. FIG. 4(a) corresponds to a usage rule where no noise is added for the first few copies made of the original. Thereafter, noise is added linearly as the number of copies increases. When the quality degradation is such that subsequent copies are at advertisement quality or some other threshold, no additional noise is added for additional copies. Of course, this model can be varied in any convenient way. For example, instead of adding noise to degrade the copies, the system could increasingly distort the frequency content of the signal produced in response to the digital data, or for scalar data, the system could increasingly reduce the numerical accuracy of the data.

In FIG. 4(b), the degradation specification model corresponds to a usage rule where noise is added exponentially as the number of copies is increased. This continues until the content reaches advertisement quality or any other suitable threshold. Thereafter, no additional noise is added with increasing copies. This specification model is a y-derivative of the previous specification model.

FIG. 5 illustrates a (x-b) and (y-b) degradation specification model. Here, added degradation depends on copy frequency rather than number of copies made. FIG. 5(a) corresponds to a usage rule where a constant amount of noise is added regardless of the copy frequency. FIG. 5(b) corresponds to a usage rule where the amount of additive noise increases linearly as the copy frequency increases. FIG. 5(c) corresponds to a usage rule where the amount of noise added increases exponentially as the frequency of copying increases. Again, any suitable type of noise or other degradation may be provided to meet specific design goals.

The degradation specification models described herein may be implemented in any convenient form now known or later developed. Current examples include computer readable source code for controlling a processor in performance of the degradation specification model or code which may be converted to a computer readable format; a digital signal processor programmed to implement one or more of the degradation specification models; or a hard-wired signal processing device which implements a digital data degradation model. The choice of a particular implementation of a model will depend on factors like cost of the completed device, input and output bandwidth, power consumption and other design goals.

The operation and performance of the disclosed system may be compared with available digital rights management devices. One example is Secure Digital Music Initiative (SDMI), which is an adopted standard. SDMI is based on a closed SDMI domain. SDMI is a closed system in which digital music content, once entered into the closed system, is controlled by SDMI modules and cannot leave the closed system.

A closed SDMI domain contains two major components. The first is a license compliance module or LCM, where the master copy and its usage rules reside, and portable devices, where slave copies reside. We are interested in the SDMI usage/duplication rules that govern copy operations. These copy operations are check-in, check-out, copy, and move. As currently understood, these operations must involve or go through LCM containing the master copy. In other words, the closed system does not allow check-out, check-in, copy, or move between portable devices or between a portable device and a LCM device not containing the master copy. Check-out decrements the number of permitted copies by one. This value is stored in the master copy. Check-in increments the number of permitted copies by one. Copy duplicates the master copies on another device. Move changes the resident device of the master copy, at the same time, it erases the original master copy.

Two main differences between SDMI and self-degrading digital data (SDD) are apparent. First, SDMI usage rules restrict the number of permitted copies. In contrast, SDD usage rules permit unlimited number of copies. SDD gives more flexibility to users, who may need a greater number of copies or more flexible copying rules. Second, SDMI usage rules always give perfect quality to permitted copies. In contrast, SDD can degrade the quality of permitted copies. SDD protects content providers in a different way than SDMI.

The flexibility to consumers, in number of copies, brings out a great advantage of SDD. It is expected that consumers are going to own multiple devices that may be upgraded many times over the lifetime of a digital content. As a result, they are going to move and copy contents many times over the lifetime of the contents, even if these copies are only for personal use. But SDMI limits the number of copies that may be made by consumers; hence it requires consumers to keep track of master and slave copies. This creates inconvenience to consumers—they may lose one or more of the check-out copies by accidental deletion, they may lose track of where they place the check-out copy on which device, and so forth. Due to carelessness or forgetfulness, some consumers can easily run out of the number of permitted copies. As a result, we believe that if content providers restrict the number of copies, this gives average consumers incentives to go out of their way to break the closed system. A closed system running on an open environment cannot be perfect and is breakable.

Note that SDD does not introduce an alternative approach for replacing the master copy concept in SDMI. The master copy concept is inconvenient for consumers, who have to keep track of which device contains master/slave copy. But it is necessary to keep track of the total number of copies that come from a single source. Putting a hard limit on the number of permitted copies increases this inconvenience, and it is unforgiving to consumers who simply lose track of their copies.

Degrading data is a good alternative solution for providing this flexibility. The degradation concept will be acceptable to users. Degradation is modeled based on generational loss in analog audio that consumers are accustomed to, e.g., when they record TV programs and replay them at a lower quality at a later time. The recording and playback processes introduce noise and degradation at an acceptable level. Degradation is flexible in that content providers can use degradation only as a guard against people who make more than enough copies for personal usage, and not against average users. Content providers can specify that degradation be unnoticeable for personal use copies, and very noticeable after frequent copies. Since SDD keeps track of the copy history, content providers can describe degradation policies based on the copy history. Degradation offers users an important flexibility/trade-off—if they wants to make more copies, they will pay a penalty in quality. The SDD degradation rules can cover the SDMI usage rules as a special case.

Another example of an available digital rights management device is the Electronic Media Management System (EMMS) developed by IBM. It is currently deployed by NTT DoCoMo on its content distribution service called M-Stage. EMMS is a closed system like SDMI. This system consists of portable devices such as cell phones or wireless players, Memory Stick® memory storage devices available from Sony Corp., and personal computers (PCs). Memory storage devices are used to store digital contents and to move them between PCs and portable devices. The master copy is kept on a PC. Any copy operation such as check-in, check-out, move, must involve the master copy. EMMS usage and duplication rules are similar to SDMI usage and duplication rules. In EMMS, move requires that all checked out copies be checked into the master copy. This is to avoid permanently losing the number of permitted copies after move. In general, content providers set the number of permitted checked-out copies to be in the range 1 to 3, and the number of moves is in the range 0 to 1. The cost per download is $1 to $3 per song, excluding packet fees.

Average users are not familiar with usage/duplication rules such as the check-in and check-out concepts. Although they may sound simple, they are complex to understand by average consumers and they cause inconvenience to them. For example, if a user wants to share music with her friend, she checks out a copy to her friend's Memory Stick® device from her PC. It would be difficult to keep track of and reclaim that checked-out copy (e.g., having her friend check in her Memory Stick® with her PC). Using SDD, it is not necessary to check in any copies back into the master copy, as long as the user does not perform too many slave copies to cause noticeable degradation.

From the foregoing, it can be seen that the present embodiments provide for self-degrading digital data which mimics the analog duplication process. This is a process that has historically worked for both users who need convenient access to a limited number of copies of content and for content providers who need to control the reproduction of their content. Self-degrading digital data frees the user from cumbersome, complex and inconvenient usage rules of present digital rights management systems. Self-degrading digital data gives content providers the freedom to distribute their content according to their usage policy of choice. This gives great flexibility, such as using one usage policy during a promotion period and another usage policy when the selected content is in demand by users. Also, particular usage policies can be tailored to particular users. University and other academic users may be provided with one usage policy while commercial users are provided with another policy.

It is to be understood that a wide range of changes and modifications to the embodiments described above will be apparent to those skilled in the art and are contemplated. It is therefore intended that the foregoing detailed description be regarded as illustrative rather than limiting, and that it be understood that it is the following claims, including all equivalents, that are intended to define the spirit and scope of the invention.

1. A method comprising:
receiving digital data; and
after use of the digital data, degrading quality of the digital data.

2. The method of claim 1 wherein degrading the quality of the digital data comprises:
varying the digital data to reduce audible reproduction quality of audio produced in response to the digital data.

3. The method of claim 2 wherein degrading the quality of the digital data comprises:
varying the digital data to distort the audio produced in response to the digital data.

4. The method of claim 2 wherein degrading the quality of the digital data comprises:
varying the digital data to introduce noise into the audio produced in response to the digital data.

5. The method of claim 2 wherein degrading the quality of the digital data comprises:
varying the digital data to vary the signal to noise ratio of the a signal produced in response to the digital data.

6. The method of claim 1 wherein degrading the quality of the digital data comprises:
varying the digital data to reduce visual reproduction quality of video produced in response to the digital data.

7. The method of claim 1 wherein degrading the quality of the digital data comprises:
producing a copy of the digital data; and
introducing predetermined error characteristics into the copied digital data.

8. The method of claim 1 further comprising:
forwarding the degraded digital data to a data destination.

9. A data processing method, the method comprising:
initiating a copy operation on digital data to be copied;
copying the digital data according to a degradation policy to produce degraded digital data; and
storing the degraded digital data at a data destination.

10. The method of claim 9 further comprising:
identifying a degradation specification model; and specifying a degradation policy based on a chosen degradation specification model.

11. The method of claim 10 wherein identifying the degradation specification model comprises retrieving the degradation specification model from the digital data.

12. The method of claim 9 further comprising:
after copying the digital data, storing an entry reflective of the copying in a duplication log.

13. The method of claim 12 further comprising:
before copying the digital data, retrieving the duplication log from storage; and
copying the digital data according to the duplication log.

14. The method of claim 13 wherein copying the digital data according to a degradation policy comprises:
copying the digital data substantially identically to produce the degraded digital data until a maximum copy threshold has been exceeded.

15. The method of claim 13 wherein copying the digital data according to a degradation policy comprises:
copying the digital data substantially identically to produce the degraded digital data until a maximum copy rate has been exceeded.

16. A method of providing content for use by one or more end users, the method comprising:
storing in a distribution file digital data associated with the content;
storing in the distribution file a degradation policy defining how the digital data should be degraded after usage by a receiving end user; and
distributing the distribution file.

17. The method of claim 16 further comprising:
storing in the distribution file a duplication log indicating a duplication history for the digital data.

18. The method of claim 16 further comprising:
encoding at least the digital data according to a standard coding format.

19. A data processing device comprising:
a communication interface configured to receive distribution files including application data;
memory means coupled to the communication interface for storing digital data including one or more distribution files;
a processor coupled to the memory and configured to operate in response to the stored digital data; and
at least one distribution file storable in the memory means and including
specific application data to control the data processing device to produce a desired operation,
degradation policy information defining how the specific application data should be degraded by the data processing device.

20. The data processing device of claim 19 wherein the specific application data comprises data encoding audio information for playback by the data processing device.

21. The data processing device of claim 19 wherein the specific application data comprises data encoding video information for playback by the data processing device.

22. The data processing device of claim 19 further comprising:
a user interface permitting control of the data processing device.

23. A method comprising:
retrieving digital data from a storage medium;
providing output information using the digital data; and
in conjunction with the use of the digital data, degrading the digital data.

24. The method of claim 23 wherein degrading the digital data comprises degrading the digital data after the use of the digital data.

25. The method of claim 23 wherein degrading the digital data comprises degrading the digital data before the use of the digital data.

26. A digital data degradation model comprising:
apparatus which degrades digital data according to a cumulative number of copies of the digital data in conjunction with use of the digital data.

27. The digital data degradation model of claim 26 wherein the apparatus comprises computer readable program code configured to control a processing device.

28. The digital data degradation model of claim 26 wherein the apparatus comprises a signal processing device.

29. The digital data degradation model of claim 26 wherein the apparatus comprises a digital signal processor.

30. A digital data degradation model comprising:
an apparatus which degrades digital data according to rate of copy operation of the digital data associated with the use of the digital data.

31. The digital data degradation model of claim 30 wherein the apparatus comprises computer readable program code configured to control a processing device.

32. The digital data degradation model of claim 30 wherein the apparatus comprises a digital signal processor.

33. A digital data degradation model comprising:
apparatus which degrades digital data according to cumulative degradation relative to an original copy of the digital data.

34. The digital data degradation model of claim 33 wherein the apparatus comprises computer readable program code configured to control a processing device.

35. The digital data degradation model of claim 33 wherein the apparatus comprises a digital signal processor.
